(19) United States
(12) Patent Application Publication
(10) Pub. No.: US 2010/0294083 A1
(43) Pub. Date: Nov. 25, 2010

(54) TOOL FOR REMOVING A POUR SPOUT FROM A BOTTLE

(75) Inventor: Mark S. Hastings, Indian Rocks Beach, FL (US)

Correspondence Address: THE BAYSHORE LAW GROUP PLLC, 400 N. ASHLEY DRIVE, SUITE 2010, Tampa, FL, 33602, US

(73) Assignee: BarProducts.com Inc., Largo, FL (US)

(21) Appl. No.: 12/721,154

(22) Filed: Mar. 10, 2010

Related U.S. Application Data
(60) Provisional application No. 61/216,783, filed on May 21, 2009.

(51) Int. Cl. B67B 7/00

(52) U.S. Cl. 81/3.47

(57) ABSTRACT

A tool (10) for removing a pour spout from the neck (22) of a bottle (20) has an elongate body with a first end (11) and a second end (13). Positioned at or near first end is an aperture (12) in communication with a channel extending toward the second end of the tool. The channel is substantially V-shaped in that a leading end of the channel is wider than the trailing end of the channel. The barrel of the pour spout becomes increasingly deformed, relative to its normal state, as it travels from the leading end of the channel towards the trailing end of the channel. A flange (32) of the pour spout may be bonded to the rim of an opening of the neck (22) of the bottle (20) by a dried liquid having a high sugar content, if the content of the bottle was such a liquid. The leading end of the channel further includes a pair of wedges (18) positioned to facilitate breaking such a bond. The wedges provide additional leverage in separating the pour spout from the bottle.

### FIELD OF INVENTION

This invention relates generally to the field of tools used for removing closures from bottles, and more specifically to tools used to remove a pour spout from a bottle.

### BACKGROUND OF THE INVENTION

After the original closure of a container containing a liquid having sugar as an ingredient has been removed, the original closure may be reinstalled on the container, or a replacement closure may be installed on the container in place of the original closure. In cases where the contents of the container, for example a glass or polymer bottle, is a liquid such as an alcoholic substance or a syrup with a significant sugar content, the reinstalled original closure or replacement closure may become adhered to the container as a quantity of the sugar containing liquid is trapped between the closure and the container and dries. It is well known that removing the closure from a bottle when this common phenomenon occurs can be difficult. One type of replacement closures that are widely used for bottles containing alcoholic and syrupy liquids are pour spouts. The general structure of pour spouts is well known, being taught for example in U.S. Pat. No. 3,966,099. Pour spouts are designed to be used repeatedly with a series of bottles, so it is desirable to easily and efficiently remove a pour spout from a bottle without damaging the pour spout, even if the pour spout is adhered to the bottle by a dried sugary liquid in the manner that has been described.

### SUMMARY OF INVENTION

There is provided in accordance with the present invention a tool for removing a pour spout from the neck of a bottle. The tool is an elongate body having a first end and a second end. Positioned at or near the first end is an aperture in communication with a channel extending toward the second end of the tool. The channel is substantially V-shaped in that an end of the channel intersecting the aperture is wider than the opposing end of the channel. By virtue of the arrangement, the barrel of a pour spout becomes increasingly deformed, relative to its normal state, as it is forced to travel along the channel from a wider end of the channel towards a narrower end of the channel.

At least one wedge is located at the intersection of an edge of the channel with an edge of the aperture to facilitate removal of the pour spout from the bottle. The wedges provide leverage in separating the pour spout from the bottle as well as provide a chipping surface separating a flange of the pour spout from the rim of an opening of the neck of a bottle when the flange and rim are bonded together by a dried liquid having a high sugar content.

### BRIEF DESCRIPTION OF THE DRAWINGS

For a fuller understanding of the invention, reference should be made to the following detailed description, taken in connection with the accompanying drawings, in which:

FIG. 1A is a top plan view of a tool in accordance with one embodiment of the invention;

FIG. 1B is a perspective view of the tool of FIG. 1A;

FIG. 1C is a cross-section of the tool taken along plane 6-6 of FIG. 1A;

FIG. 2A is perspective view of the tool positioned to remove a pour spout from the neck of a bottle;

FIG. 2B is a perspective view of the tool in the deployed position;

FIG. 3 is a side elevation view showing the pour spout being fully removed from the neck of the bottle with the tool;

FIG. 4A is a bottom plan view of the tool positioned to remove a pour spout from the neck of a bottle (bottle not shown);

FIG. 4B is a bottom plan view of the tool in the deployed position.

### DETAILED DESCRIPTION OF THE INVENTION

In the following detailed description of the invention, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

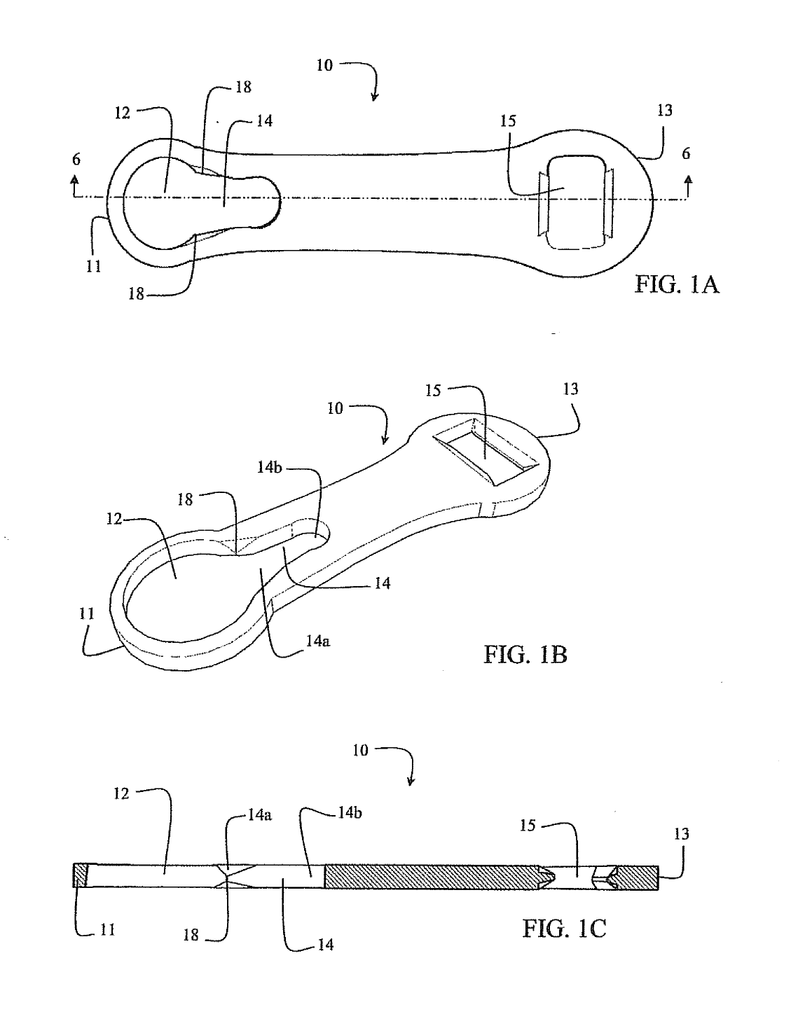

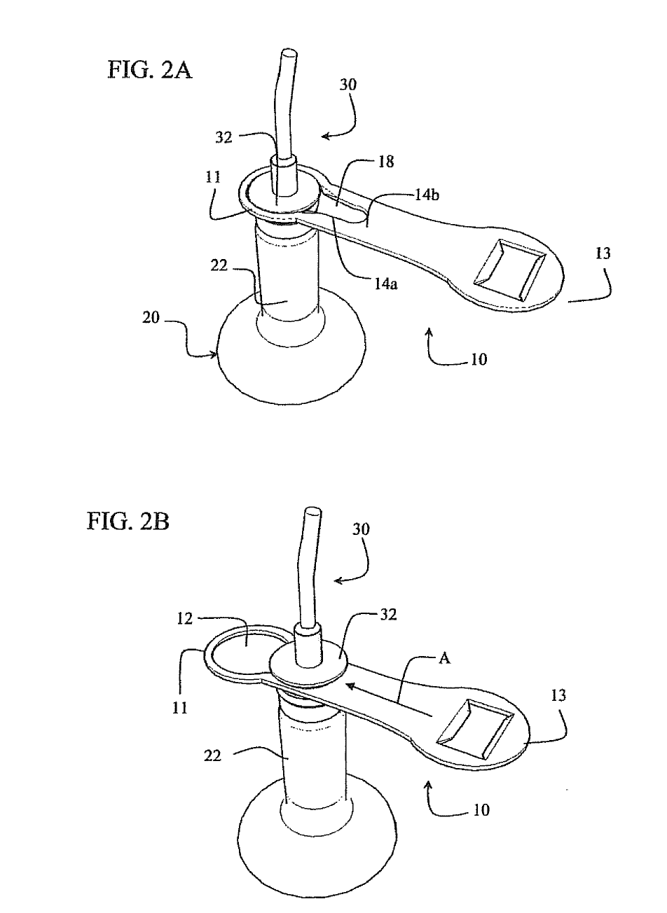

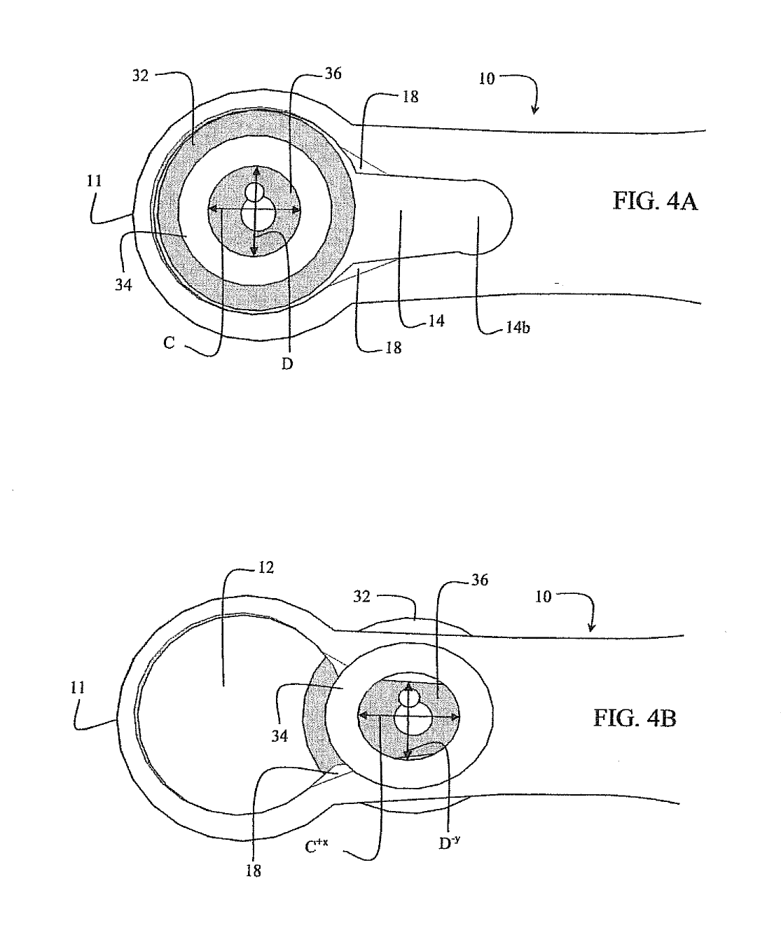

The invention provides a tool for removing a pour spout from the neck of a bottle. Referring now to the illustrative embodiment shown in FIGS. 1A-1C; a tool 10 has an elongate body having upper and lower surfaces and a first end 11 and a second end 13. The elongate body comprises a material having sufficient strength and rigidity to withstand the forces that the tool will be subjected to when used for its intended purpose. Examples of such materials are metals and polymers. Positioned at or near the first end 11 of the elongate body are an aperture 12 through the elongate body and a channel 14. As viewed looking towards the upper or lower surfaces of the elongate body the aperture has a substantially circular or arcuate shape. The channel intersects and communicates with the aperture and has side edges that converge as the channel extends from the aperture 12 towards the second end 13 of the elongate body. As viewed looking towards the upper or lower surfaces of the elongate body the channel 14 is substantially V-shaped. As shown in FIGS. 1B and 1C a leading end 14a of the channel 14 is wider than a trailing end 14b of the channel. The disclosed configuration of the aperture and channel causes the barrel 36 of a pour spout 30 to be increasingly deformed relative to its normal state in the neck 22 of a bottle 20 as the tool is moved relative to the barrel of the poor spout with the barrel traveling from the leading end 14a towards the trailing end 14b of the channel 14, as shown in FIGS. 2A, 2B, 4A and 4B. The second end 13 of the tool can include an additional tool such as a bottle opener 15.

At an intersection of at least one edge of the channel 14 with an edge of the aperture 12 the elongate body has a reduced thickness as compared with the thickness of the elongate body at the adjacent edge of the aperture and the adjacent edge of the channel. The reduced thickness of the elongate body is in the form of a wedge 18. In the illustrated embodiment each of the intersections of the edges of the channel 14 with the edge of the aperture 12 has a reduced thickness in the form of a wedge 18 as compared with the thickness of the elongate body at an adjacent edge of the aperture or an adjacent edge of the channel. Therefore, the leading end 14a of the channel includes a pair of wedges 18 positioned to facilitate removal of a pour spout from the bottle. Specifically, the wedges 18 provide additional leverage for separating the pour spout from the bottle as well as provide a chipping surface for use with bottles containing an alcoholic substance, or a syrup, with a high sugar content wherein dehydrated sugar has accumulated and bonded a flange 32 of the pour spout adjacent a rim of an opening in the neck 22 of the bottle 20. This bond makes removal of the pour spout from the neck of the bottle difficult.

As shown in FIG. 1C a thinnest part of the wedge 18 is substantially midway between the upper and lower surfaces of the elongate body of the tool 10. Alternatively, a thinnest part of the wedge may be substantially adjacent either the upper or lower surface of the elongate body of the tool 10.

Operation of the tool 10 to facilitate removal of a pour spout 30 from the neck 22 of a bottle 20 is shown in FIGS. 2A and 2B. The aperture in the elongate body of the tool has a size such that a portion of the pour spout 30 extending beyond the neck 22 of a bottle 20 can pass through the aperture allowing wedges 18 formed the intersection of the at least one edge of the channel with the aperture to be aligned with an intersection of the flange 32 of the pour spout with the rim of an opening in the neck of such that the wedge can be forced between the flange of the pour spout and the rim of the opening in the neck of the bottle. In FIG. 2A the tool 10 is positioned such that the pour spout 30, including the flange 32, passes through the aperture 12 in the elongate body of the tool. In this position, the leading end 14a of the channel 14 is adjacent intersection of the flange 32 and the upper-most extent of bottle neck 22. The wedges 18 are also positioned adjacent the interface between the rim of the opening in the neck 22 of the bottle and a lower surface of the flange 32 of the pour spout. FIG. 2B shows that the flange 32 of the pour spout is separated from the bottle neck 22 when the tool 10 is deployed in a direction indicated by an arrow A such that the tool is moved relative to the barrel of the poor spout with the barrel traveling from the leading end 14a towards the trailing end 14b of the channel 14.

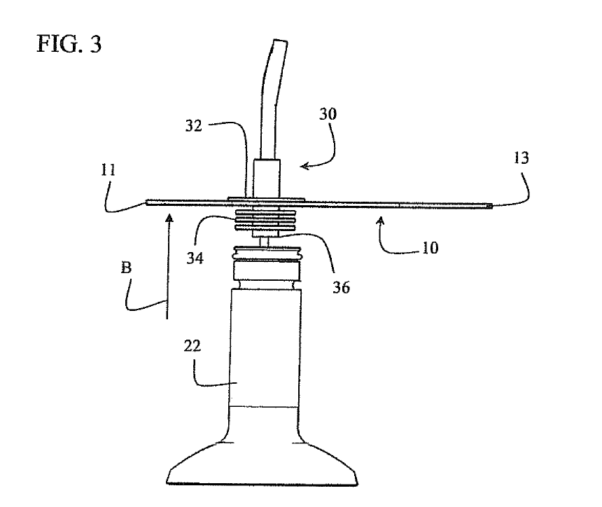

FIG. 3 shows that the pour spout 30 is easily removed once the tool 10 has been deployed as described above. An upward pivotal force on the tool 10, such as that shown by arrow B, fully removes the pour spout 10 as the gaskets 34 and barrel 36 clear the neck 22 of the bottle 22.

Examples of some of the advantages of the V-shaped channel 14 are shown in FIGS. 4A and 4B. Most common pour spouts comprise a barrel 36 with longitudinally spaced radially outward projecting circular sealing gaskets 34 below a flange 32, as shown in FIG. 3. The gaskets 34 are substantially pliable which enables them to make a liquid-tight seal with an interior surface of the neck 22 of the bottle. The barrel 36 of the pour spout is commonly made from of a more rigid material and it supports the gaskets.

In FIG. 4A, a gasket 34 and barrel 36 in the neck of a bottle (not shown) are substantially circular in cross-section. The barrel 36, for example has substantially equal axis C and D when disposed within the aperture 12. As the tool 10 is deployed, shown in FIG. 4B, the barrel 36 is deformed relative to its normal state. As a result, the axis C is increased by a value x and the axis D is decreased by a value y. This deformation helps break the liquid-tight seal between the pour spout 30 and the inner surface of the neck of the bottle.

The deformation caused by the V-shaped channel 14 allows the tool 10 to apply rotational force to the pour spout 30. If the width of the trailing end 14b of the channel 14 was the same as the width of the leading end 14a of the channel, then twisting of the tool 10 would not result in any appreciable force being transferred to the pour spout 30. The deformation afforded by the V-shaped channel provides friction which allows rotation force to be placed on the pour spout 30 in addition to lateral and lifting forces.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall there between.

What is claimed is:

1. A tool for removing a pour spout from a neck of bottle comprising:
(a) an elongate body having upper and lower surfaces and a first end and a second end;
(b) an aperture through the elongate body near the first end of the elongate body; and
(c) a channel through the elongate body, the channel intersects the aperture and has edges that converge as the channel extends from the aperture towards the second end of the elongate body, wherein at an intersection of at least one edge of the channel with an edge of the aperture the elongate body has a reduced thickness as compared with the thickness of the elongate body at the adjacent edge of the aperture and the adjacent edge of the channel.

2. The tool of claim 1, wherein the reduced thickness of the elongate body is in the form of a wedge.

3. The tool of claim 2, wherein a thinnest part of the wedge is substantially midway between the upper and lower surfaces of the elongate body.

4. The tool of claim 2, wherein a thinnest part of the wedge is substantially adjacent either the upper or lower surface of the elongate body.

5. The tool of claim 1, wherein the channel is substantially V-shaped when viewed looking towards the upper or lower surfaces of the elongate body.

6. The tool of claim 1, wherein the edges of the channel are spaced apart at the intersection of the edges of the channel with the edge of the aperture a distance greater than the diameter of a barrel of a pour spout.

7. The tool of claim 1, wherein as the edges of the channel converge the edges of the channel are spaced apart a distance less than the diameter of the barrel of a pour spout.

8. The tool of claim 1, where the aperture has a size that is large enough to allow a portion of the pour spout extending beyond a neck of a bottle to extend through the aperture.

9. The tool of claim 1 wherein at each of the intersections of the edges of the channel with the edge of the aperture has a reduced thickness in the form of a wedge as compared with the thickness of the elongate body at an adjacent edge of the aperture or an adjacent edge of the channel.

10. A tool for removing a pour spout from a neck of a bottle wherein a flange of the pour spout is disposed adjacent a rim of an opening in the neck of the bottle is bonded to the rim by dried residue of liquid originally contained in the bottle, the tool comprising:
(a) an elongate body having upper and lower surfaces and a first end and a second end;
(b) an aperture through the elongate body near the first end of the elongate body; and
(c) a channel through the elongate body, the channel intersects the aperture and has edges that converge as the channel extends from the aperture towards the second end of the elongate body, wherein at an intersection of at least one edge of the channel with an edge of the aperture the elongate body has a reduced thickness in the form of a wedge as compared with the thickness of the elongate body at the adjacent edge of the aperture and the adjacent edge of the channel;
wherein the aperture has a size such that a portion of the pour spout extending beyond the neck of a bottle can pass through the aperture allowing the wedge to be aligned with an intersection of the flange of the pour spout with the rim of the neck of bottle, such that the wedge can be forced between the flange of the pour spout and the rim of the opening in the neck of the bottle.

11. The tool of claim 10, wherein a thinnest part of the wedge is substantially midway between the upper and lower surfaces of the elongate body.

12. The tool of claim 10, wherein a thinnest part of the wedge is substantially adjacent either the upper or lower surface of the elongate body.

13. The tool of claim 10, wherein the channel is substantially V-shaped when viewed looking towards the upper or lower surfaces of the elongate body.

14. The tool of claim 10, wherein the edges of the channel are spaced apart at the intersection of the edges of the channel with an edge of the aperture a distance greater than the diameter of a barrel of a pour spout.

15. The tool of claim 10, wherein as the edges of the channel converge the edges of the channel are spaced apart a distance less than the diameter of the barrel of a pour spout.

16. The tool of claim 10 wherein each of the intersections of the edges of the channel with the edge of the aperture has a reduced thickness in the form of a wedge as compared with the thickness of the elongate body at an adjacent edge of the aperture or an adjacent edge of the channel.
